(19) United States
(12) Patent Application Publication
(10) Pub. No.: US 2003/0115194 A1
(43) Pub. Date: Jun. 19, 2003

(54) Method and apparatus for processing a query to a multi-dimensional data structure

(76) Inventors: Theodore H. Pitts, San Mateo, CA (US); Rolfe R. Schmidt, Los Angeles, CA (US); Derek A. Lewsey, Castro Valley, CA (US)

Correspondence Address: Finnegan, Henderson, Farabow,, Garrett & Dunner, L.L.P., 1300 I Street, N.W., Washington, DC, 20005-3315, US

(21) Appl. No.: 10/211,862

(22) Filed: Aug. 1, 2002

Related U.S. Application Data
(60) Provisional application No. 60/309,637, filed on Aug. 1, 2001.

(51) Int. Cl. G06F 7/00

(52) U.S. Cl. 707/3

(57) ABSTRACT

Consistent with the invention, a method includes receiving dimension solve order rules associated with a set of calculated members, and using the received dimension solve orders rules to translate a client query into a different query with corresponding solve orders.

### RELATED APPPLICATION

This application claims priority to U.S. Provisional Application Serial No. 60/309,637 entitled “METRICS ENGINE”, filed on Aug. 1, 2001, which is incorporated herein by reference in its entirety.

### FIELD OF THE INVENTION

The present invention relates to multi-dimensional database systems and, more particularly, to a method and apparatus for processing a query to a multi-dimensional data structure.

### BACKGROUND

Digital computer systems have become a ubiquitous mechanism for storing and manipulating information. Databases are organized collections of data that are suitable for efficient manipulation by a digital computer system.

A Relational Database model involves sets of data, frequently referred to as tables, wherein the data is arranged in rows and columns. In a Relational Database Management System (“RDBMS”), the information within tables may have highly flexible inter-relationships. A query description may define the relationships at the time data is accessed rather than requiring structural relationships between data to be built into a structure of a database. By relating multiple tables by shared indexes or tags, data may be normalized and one to many relationships between elements defined by multiple tables may be implemented in a relational database system without duplication of information. Normalization is the process of decomposing a set of data definitions into tables that are related by a common index.

When enterprise data is stored in a vast data repository, the repository is sometimes referred to as a data warehouse. A data warehouse may be designed to provide targeted access to particular information that is necessary for management decision-making. Data warehouses may contain a wide variety of data that are intended to present a coherent picture of business conditions at predetermined points in time. Data warehouses are typically designed to facilitate information extraction from vast transactional data by providing managers with powerful and flexible access to the information.

A Relational Database Management System may provide a suitable environment for manipulating and processing enterprise data. For instance, a Relational Database model provides a relatively easily learned, general-purpose model supporting ad hoc queries of related information. In addition to providing a standardized access model, a RDBMS may provide mechanisms for allowing multiple access points to information while also providing mechanisms to preserve the integrity of stored information by protecting data from being improperly overwritten when there are multiple writes taking place. A RDBMS may also provide mechanisms for rolling-back certain operations in the case of certain error conditions, etc.

Accordingly, a RDBMS may provide a suitable environment for enterprise data. Furthermore, structured query languages (“SQL”) may be suitable for manipulating information in a RDBMS. Although a RDBMS may provide a suitable environment for manipulating and processing enterprise data, when a conventional RDMBS reaches a certain size and complexity, conventional interfaces and reporting mechanisms may become cumbersome and it becomes increasingly difficult to write queries that extract needed information. Therefore, other techniques are needed to facilitate access to information contained in vast data warehouses.

On-Line Analytical Processing (“OLAP”) is a term used to describe a database processing strategy for accessing information stored in a data warehouse. OLAP engines may share several common attributes, including an ability to provide a multi-dimensional conceptual view of information. A multi-dimensional conceptual view refers to a hierarchical view into a business or organization. A multi-dimensional database uses a concept of a cube to represent the dimensions of data available to a client. For example, “Sales” could be viewed in the dimensions of product, geography, time, or some additional dimension. Additionally, a dimension may have defined hierarchies and levels within it, e.g., state and city levels within a regional hierarchy.

A cube is the unit level building block of a multi-dimensional database. A cube is made up of a plurality of dimensions related to the entity that the cube describes. A common example of a multi-dimensional data cube is a “sales” cube, with each sales data element at the intersection of the dimensions “product”, “time”, and “geography.” By analysis of the “sales” cube, sales of a particular product over time and location may be accessed and considered.

A cube may be implemented using a RDBMS by generating fact tables that are associated with different dimensions. In such an implementation, queries may consist simply of requesting all the facts associated with specified values of dimensions. For example, if a fact table describes sales, sales for product x, geography y, and time z may be requested.

One way to access information in a multi-dimensional database is to prepare and communicate a query to the database. A result of a query may be called a dataset. A dataset is itself a multi-dimensional data structure of a dimension that is dependent on the query and the number of dimensions of the cube or cubes to which the query was directed. Dimensions of a dataset may be called axes.

Multi-dimensional Expressions (“MDX”) is a query language developed to express multi-dimensional queries. MDX is similar to SQL and may be implemented as a set of macros built on a SQL language foundation. An MDX syntax is described in the publication Microsoft™ OLE DB for OLAP Programmer's Reference, published December 1998 by Microsoft™ Corporation of Redmond, Wash.

An underlying data source, such as Microsoft™ SQL Server Analysis Services 2000™, may interpret and resolve a MDX query. In addition, the underlying data source may formulate a response to the MDX query.

A MDX query may include an “aggregate” function to produce a summarization of information. An underlying data source, such as Analysis Services 2000™, supports the “aggregate” function by returning a calculated value using an appropriate function, based on an aggregation type corresponding to a current measure. The measure may be an ordinary member which corresponds to a point in a cube, such as, for example: [Measures].Qty. Alternatively, the measure may be a calculated member, i.e., a member which corresponds to information defined by a MDX expression, e.g., Sum({[Inventory].[On Hand]}, [Measures].[Qty]) ]) where Sum ({Dimension}, Cube Measure). Although an underlying data source, such as Analysis Services 2000™, may support the “aggregate” function across ordinary members, that function cannot be used on measures that include calculated members.

For a client application of Analysis Services 2000™ to aggregate data across calculated members, the client application must specify an explicit calculation to perform, such as “sum.” The client application must also provide an appropriate “solve order” in which to perform the appropriate calculation, in relation to other solve orders that occur in a particular query. The “solve orders,” otherwise called “solve order rules,” indicate the order for performing calculations. Unfortunately, the client application can only have knowledge of the solve orders on calculated members that it established. This is problematic because, unbeknownst to the client application, there may be “global” calculated members that are shared by multiple clients. Furthermore, the client application must understand and provide appropriate solve orders for each dimension in relation to the calculated member in order to aggregate over sets with members from multiple dimensions. The underlying data source, however, neither provides sufficiently complex and flexible mechanisms for defining these calculations, nor facilitates the application of solve orders to a relationship between calculated members and other dimensions.

The foregoing principles may be better understood by reference to exemplary MDX expressions. Consider a metric called “Success Rate,” which represents a ratio of Success_Quantity to Total_Quantity (i.e. Success_Quantity/Total_Quantity) using information contained in the following table (Table T1):

TABLE T1

| | Day1 | Day2 |
|---|---|---|
| Success_Quantity | 5 | 15 |
| Total_Quantity | 10 | 20 |

Calculating “Success Rate” for Day1 yields 0.5 (i.e. 5/10). The same calculation for Day2 produces 0.75 (or 15/20). To determine a total “Success Rate” over the two days, it must be determined whether to add Day1 and Day2 before calculating the ratio or whether to first calculate the ratio for each of these days and sum the ratios. Either answer may be appropriate, depending on a definition of a corresponding metric calculation. A correct answer will require solve orders being applied to the two calculations involved: (i) the sum of Day1 and Day2, and (ii) the ratio of Success_Quantity to Total_Quantity. Unless the solve orders are defined as a part of the metric's definition, a correct calculation of the aggregate value of “Success Rate” cannot be accomplished.

Therefore, in order to perform the appropriate calculations, there exists a need for processing such queries to multi-dimensional data structures with corresponding solve orders.

### SUMMARY

Consistent with the invention, one method is disclosed which comprises receiving dimension solve order rules associated with a set of calculated members, and using the received dimension solve orders rules to translate a client query into a different query with corresponding solve orders.

### BRIEF DESCRIPTION OF THE DRAWINGS

The accompanying drawings, which are incorporated in and constitute a part of this specification, illustrate exemplary embodiments of the present invention and together with the description, serve to explain principles consistent with the present invention. In the drawings,

FIG. 1 illustrates a block diagram of an application environment in which methods and systems, consistent with the present invention, may be used;

FIG. 2 is block diagram illustrating an environment in which an embodiment of methods and systems, consistent with the present invention, may be used;

FIG. 3 is an exemplary block diagram that illustrates one embodiment of a system, consistent with the present invention;

FIG. 4 is an exemplary block diagram illustrating information interrelationships of a metric consistent with the present invention;

FIG. 5 shows one embodiment, consistent with the present invention, in which measures, facts, functions, components, and parameters are interrelated;

FIG. 6 shows an exemplary interface for accessing components, consistent with the present invention;

FIG. 7 shows an exemplary interface for listing and selecting components, consistent with the present invention;

FIG. 8 shows an exemplary interface for manipulating fact data structures, consistent with the present invention;

FIG. 9 shows another exemplary interface for manipulating fact data structures, consistent with the present invention;

FIG. 10 shows an exemplary interface for accessing fact data structures, consistent with the present invention;

FIG. 11 shows an exemplary interface for manipulating functions, consistent with the present invention;

FIG. 12 shows an exemplary interface for accessing functions, consistent with the present invention;

FIG. 13 shows an exemplary interface for manipulating invoked functions, consistent with the present invention;

FIG. 14 shows an exemplary interface for accessing metrics, consistent with the present invention;

FIG. 15 illustrates a flow diagram consistent with one embodiment in which absolute solve orders are calculated from a list of relative solve orders; and

FIG. 16 illustrates a flow diagram consistent with one embodiment in which the solve order generation accounts for high dependency measures.

### DETAILED DESCRIPTION

Reference will now be made in detail to exemplary embodiments consistent with the invention, examples of which are illustrated in the accompanying drawings.

Methods and apparatus are disclosed that interpret a query sent by a client, converting the query into a new query that can be resolved by an underlying data source. Rather than implementing an entire database engine, it translates the request or query into a different query with corresponding solve orders that the underlying data source can support.

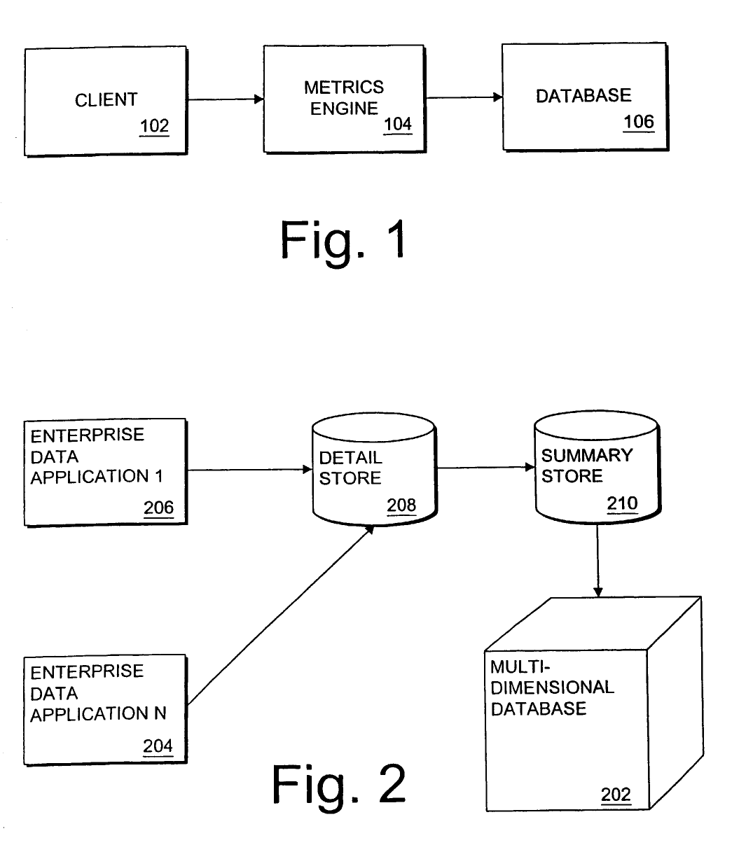

FIG. 1 illustrates a block diagram of an application environment in which methods and systems, consistent with the present invention, may be used. Client 102 is a client presentation user-interface such as, for example, Microsoft™ Excel™, a ProClarity™ SDK based client, or an arbitrary client using a data-interface, such as a generic wrapper for OLE DB for OLAP. Client 102 communicates with metrics engine 104 via an arbitrary communication mechanism. Examples of communication mechanisms include, data networks, such as, for example, wired networks, wireless networks and optical-fiber networks and combinations thereof. A communications path may traverse multiple connection-facilitating systems and devices. Alternatively, client 102 and metrics engine 104 may be implemented on one computer system. Communication between client 102 and metrics engine 104 may take the form of Extensible Markup Language (“XML”) messages transported over Transmission Control Protocol (“TCP”) formatted datagrams according to the Hypertext Transport Protocol (“HTTP”) protocol. In one embodiment, MDX expressions are incorporated in certain of the XML messages that are exchanged between client 102 and metrics engine 104.

Metrics engine 104 similarly exchanges information with database 106. An information exchange between metrics engine 104 and database 106 may take place over an arbitrary communications system such as those described in connection with a communications mechanism between client 102. Information may be exchanged between metrics engine 104 and database 106 via an exchange of TCP datagrams, containing HTTP requests and responses, in which XML encoded information is inserted. Database related communication may occur between metrics engine 104 and database 106 using a proprietary network communications protocol such as that implemented by Oracle™ Corporation of Redwood Shores, Calif. The above are not inclusive of the communication protocols that can by used. In addition, metrics engine 104 and database 106 may reside on separate computer systems or on a single computer system.

In one embodiment, metrics engine 104 provides an external interface for a client application to send metric queries using MDX. For example, the interface may be an OLE DB for OLAP provider, which is also available through an XML interface over HTTP. Metrics engine 104 parses MDX queries sent by a client application, interprets the parsed information, queries an underlying data source 106 to process the request, and formulates a response, returning the response to the requesting client application. Underlying data source 106 can comprise a relational and OLAP data source, e.g., Microsoft™ SQL Server Analysis Services 2000™.

In one embodiment, a portion of a particular client MDX query is interpreted and resolved by metrics engine 104, while other parts of a query may be passed on directly to an underlying data source, such as Analysis Services 2000™, to be resolved by this underlying data source 106. Metrics engine 104 may support the MDX language independently from any underlying data source 106. Accordingly, metrics engine 104 can support a superset of MDX syntax. For instance, metrics engine 104 may support some aspects of MDX syntax not supported by underlying data source 106 and not support other aspects supported by underlying data source 106.

For example, an underlying data source, such as Analysis Services 2000™, does not support aggregating data across multiple members, where members include calculated members. For instance, underlying data source 106 lacks mechanisms for defining aggregations of calculated members from multiple dimensions and for applying solve orders to a relationship between calculated members and other dimensions. In addition, the client application lacks access to global calculated members that are shared by multiple clients.

In contrast to the underlying data source, metrics engine 104 is capable of performing calculations on calculated members notwithstanding limitations of underlying data source 106. For example, in one embodiment, metrics engine 104 facilitates an application of the MDX language aggregate function to calculated members. For instance, global calculated members may be provided in connection with metrics engine 104 so that client 102 can have knowledge of both the calculated members it established as well as global calculated members. In addition, solve orders may be maintained with information associated with metrics engine 104. Metrics engine 104 can use this information and perform this logic when it translates a client query into a different query with corresponding solve orders that underlying data source 106 can support. In addition, metrics engine 104 can provide mechanisms for defining aggregations of members from multiple dimensions and for applying solve orders to a relationship between calculated members and other dimensions

FIG. 2 is block diagram illustrating an environment in which an embodiment of methods and systems, consistent with the present invention, may be used. Enterprise data application 206 is an original source of information for a data warehouse. Application 206 may be a custom legacy application implemented on an IBM mainframe, or it may involve a client server database architecture, such as those provided in connection with the Oracle™ database management system. Enterprise data application 204 also contributes information to the data warehouse. Information from Applications 204 and 206 are stored in detail store 208, which may be an RDBMS or another type of database system as will be apparent to one of ordinary skill. Summary store 210 contains database information corresponding to the information in detail store 208, however, the information in summary store 210 may include portions of the individual records of the information in detail store 208 that is transformed. For example, summary store 208 may include grouping of customer information, where the grouping corresponds to a total amount of purchases by customer. A transformation such as grouping by yearly customer purchases requires adding the amount of purchases. Finally, multi-dimensional database 202 is populated with information obtained from summary store 210. Transformations and denormalization of information from detail store 208 may be performed before transmitting the information into multi-dimensional database 202. Applications 204 and 206, detail store 208, summary store 210, and multi-dimensional database 202 could all reside on the same computer system. Similarly all could reside on separate systems.

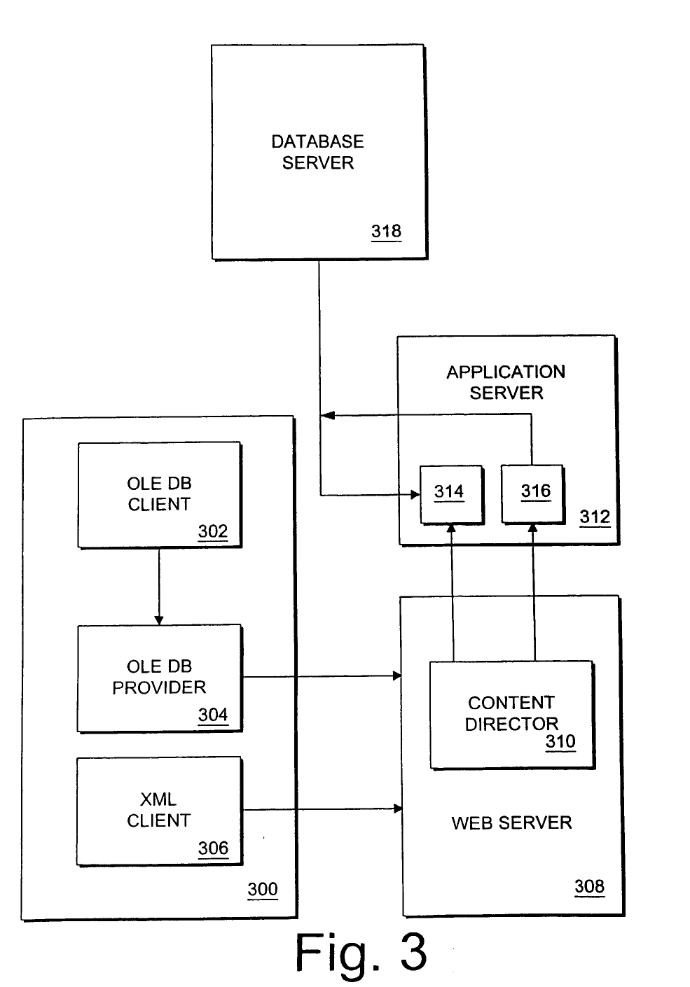

FIG. 3 is an exemplary block diagram that illustrates one embodiment of a system, consistent with the present invention. Client 300 contains OLE DB client 302 and communicates with web server 308 via OLE DB provider 304, which may be, for example, an OLE DB for OLAP provider. OLE DB provider 304 communicates with web server 308, on which content director 310 is running. Content director 310 may be implemented via ISAPI. Content director 310 may pass XML to application server 312. Via web server 308, application server 312 receives information corresponding to information communicated to and from client 300.

Application server 312 contains server objects 314 and 316 that may be implemented as COM or DCOM objects. Application objects 314 and 316 may contain logic to process the queries for converting complex MDX queries that may request aggregation over calculated members into more simple MDX queries with corresponding solve orders that may be processed by the underlying data source provided by database server 318.

In one embodiment consistent with the present invention, core objects may comprise facts, functions and components. Facts may be implemented as MDX statements that include the use of cube measures and other defined facts. A fact is often simply a direct mapping to a single cube measure. A fact may correspond to either an ordinary member or a calculated member.

Functions are MDX statements that may or may not have parameters associated with them e.g., Ratio.

Parameters may be used within MDX in connection with facts and functions. However, in one embodiment parameters may not be used in connection with cube measures.

Components are invocations of functions with facts and/or other components specified for functions' parameters. In other words, a component is a function with arguments passed to it. In one embodiment, cube measures are not used directly within the definition of a component. In this embodiment, a fact is defined as a particular cube measure and then the defined fact is used in connection with the definition of the component. In another embodiment, a component may reference cube measures directly.

Invoked functions are similar to components, but an invoked function is associated with a specific function and can take that function's parameters or its other invoked functions as parameters to that function. An invoked function provides a means to nest a function.

In one embodiment, metrics are groupings of components. In one embodiment, when queries are generated that are required to implement metrics, each metric results in generation of a single MDX query. Within each query, components associated with a metric are represented by a subset of the query's calculated members.

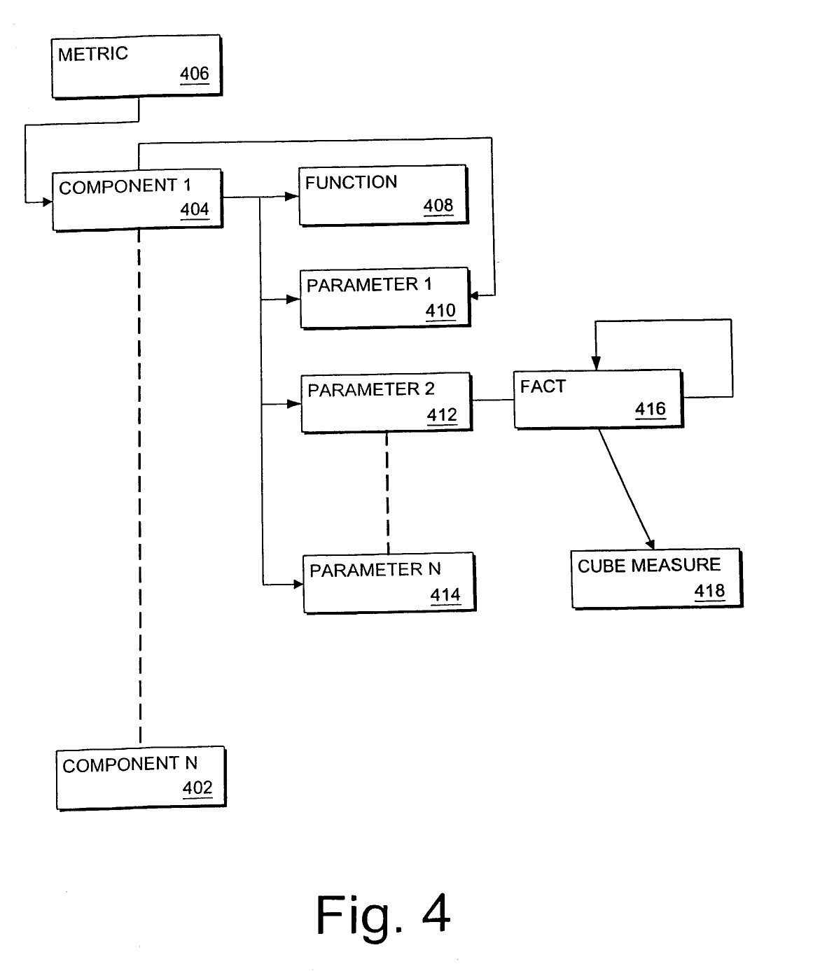

FIG. 4 is an exemplary block diagram illustrating information interrelationships of a metric consistent with the present invention. Metric 406 represents an exemplary data structure capable of particular data interrelationships. Component 404 may reference an arbitrary number of functions, such as function 408. Additionally, component 404 may reference parameters 410, 412 and 414. Parameters may reference facts such as fact 416. A fact 416 may reference another fact as well as an actual cube measure, such as cube measure 418.

In one embodiment, both facts 416 and functions 408 may have sets of dimension solve orders associated with them. In one embodiment, both facts 416 and functions 408 also have MDX code segments associated with them. In one embodiment, non-language elements referenced in the MDX segment of a fact are cube measures that exist in an actual cube in an underlying data source.

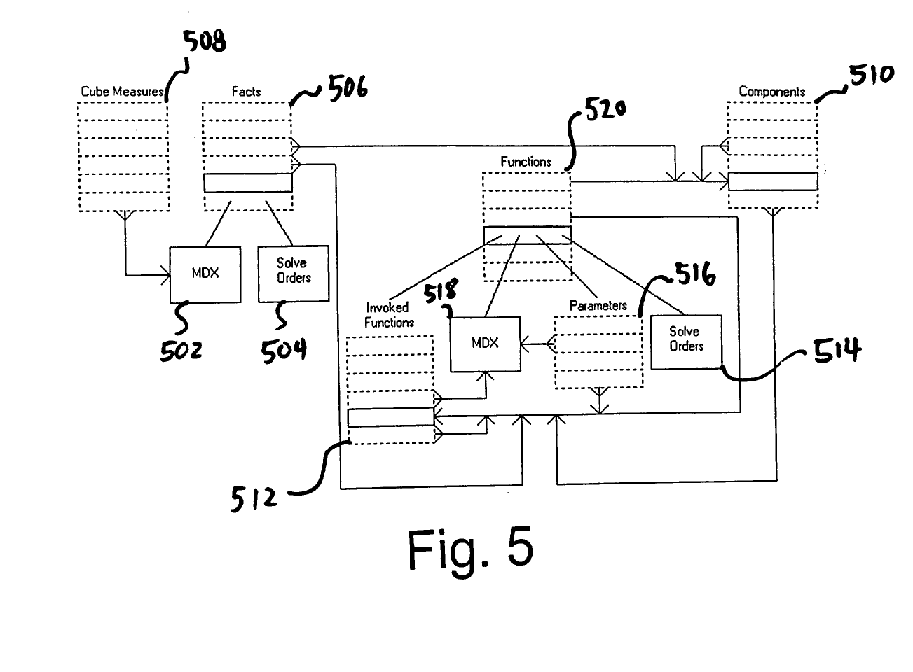

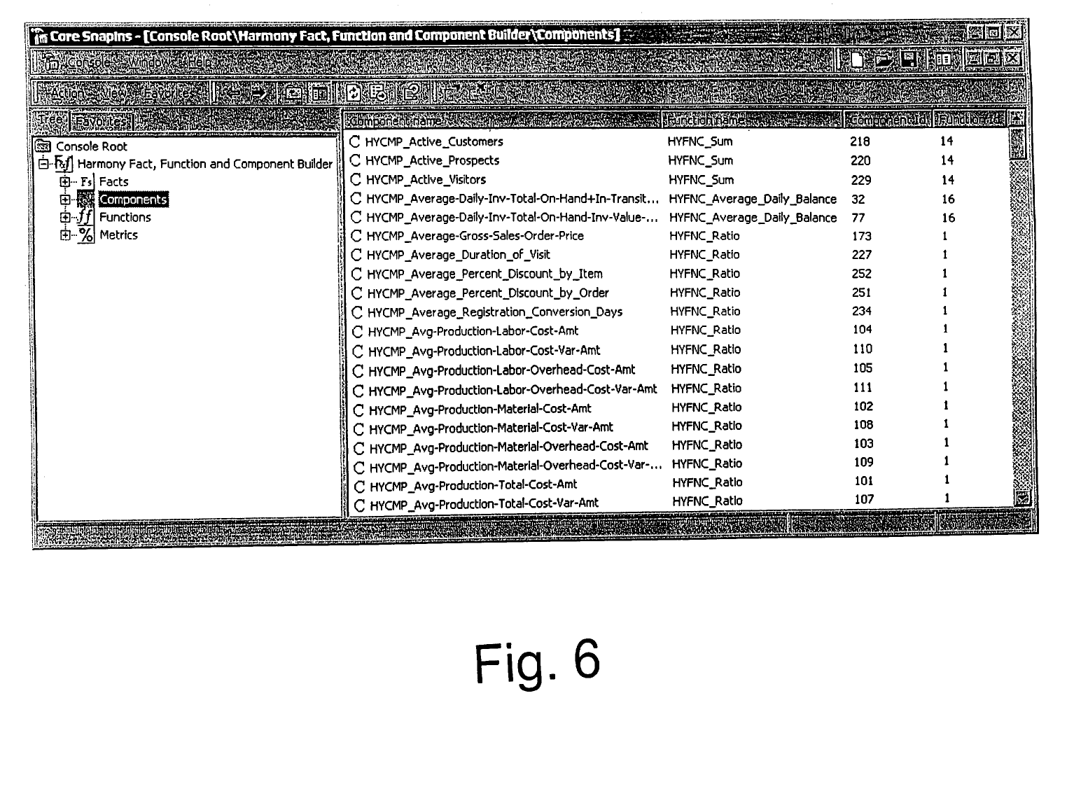

FIG. 5 shows one embodiment consistent with the present invention in which measures, facts, functions, components, and parameters are interrelated. A fact 506 may be implemented as a solve order 504 and MDX 502 that includes the use of a cube measure 508, and another defined fact. A component 510 may be implemented as a function 520 with a fact 506 and/or with another component 510 substituted for a function's parameter 516. In addition to a solve order 514 and MDX 518, a function 520 may also include a parameter list 516 and an invoked function 512. Invoked function 512 is similar to component 510 in that it consists of a function 520 whose one or more parameters 516 have been assigned component 510, fact 506, parameter 516 defined for the containing function 520, and/or another invoked function 512 defined for the containing function 520. Non-language elements referenced in an MDX segment of a function 520 may include facts, components, parameter of the function, and/or invoked functions defined for the function 520.

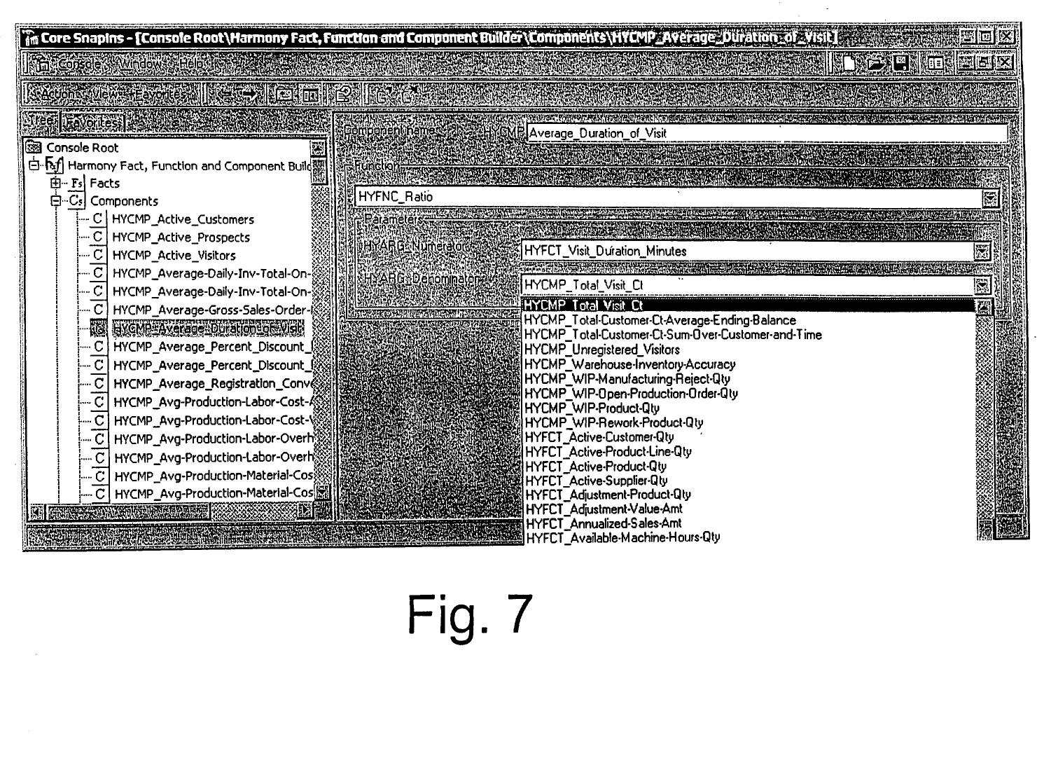

In one embodiment, an interface may be provided for accessing, listing, selecting, and/or manipulating components, facts, functions, parameters and/ or metrics. The interface may also receive dimension solve orders for facts and/or functions indicating where its associated measure should be computed in relation to a dimension. In one embodiment, this information, including the solve orders, is maintained by metrics engine 104. Exemplary interfaces consistent with the present invention are illustrated below in FIGS. 6-14.

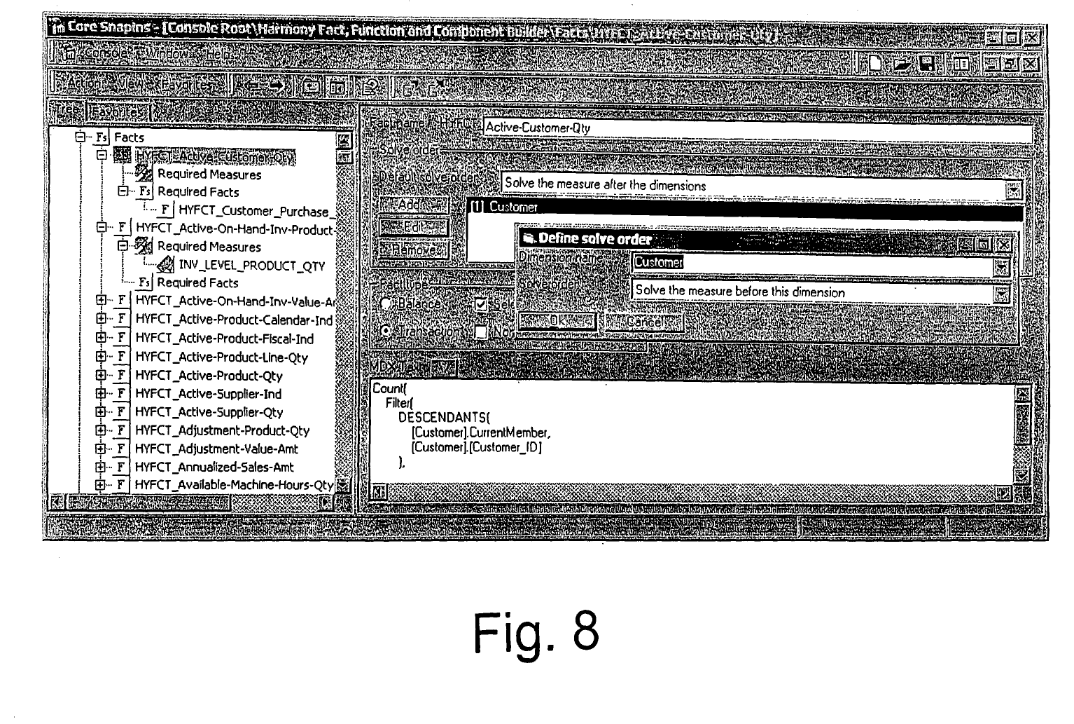

FIG. 6 shows an exemplary interface for accessing components, consistent with the present invention. FIG. 7 shows an exemplary interface for listing and selecting components, consistent with the present invention. Therein, a client can select the Function and Parameters to be associated with a Component. For instance, in FIG. 7 the Component HYCMP_Average_Duration_of_Visit is selected as well as the corresponding Function, HYFNC_Ratio and function Parameters.

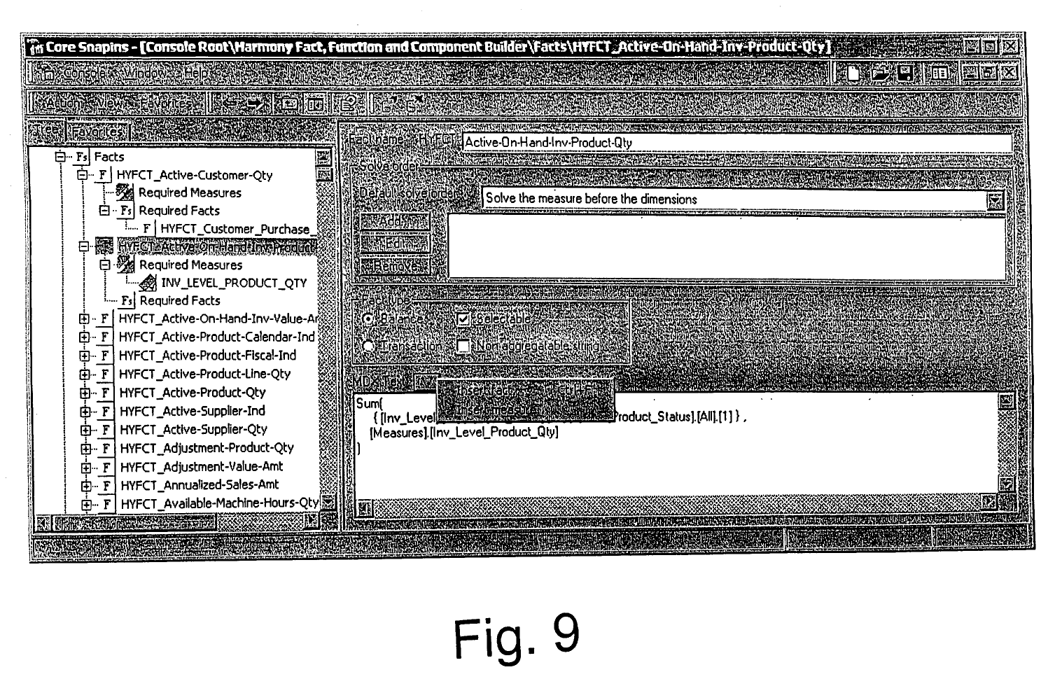

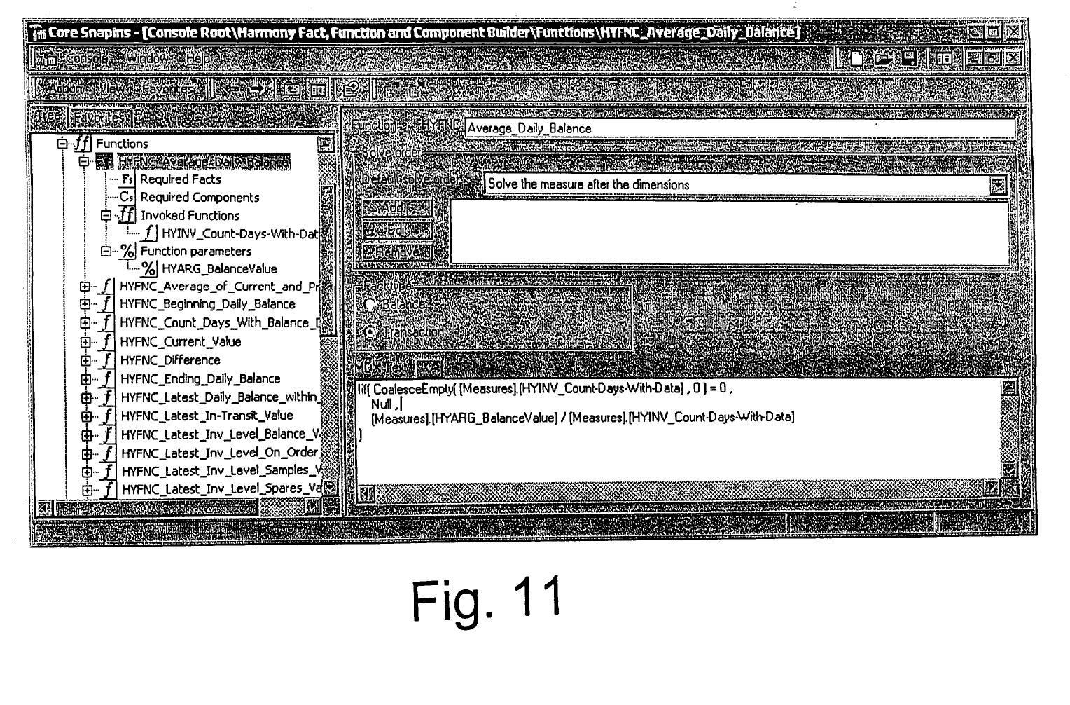

FIG. 10 shows an exemplary interface for accessing fact data structures, consistent with the present invention. FIG. 8 shows an exemplary interface for manipulating fact data structures, consistent with the present invention. In one embodiment, a client can set a dimension solve order rule for each fact indicating where a measure should be computed in relation to a dimension e.g., Solve the measure after the dimensions; Solve the measure before the dimensions; or Anywhere. MDX text can also be added to a fact description.

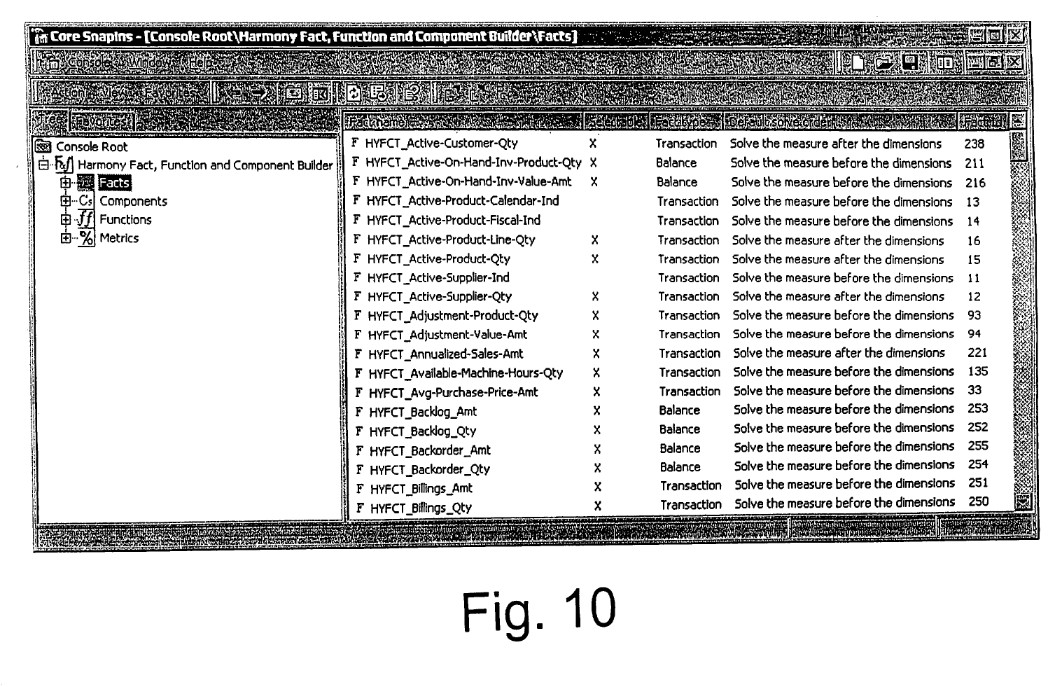

FIG. 9 shows another exemplary interface for manipulating fact data structures, consistent with the present invention. In one embodiment, a client can set the Fact Type, for example, to a High Dependency Measure such as a Non-aggregatable string.

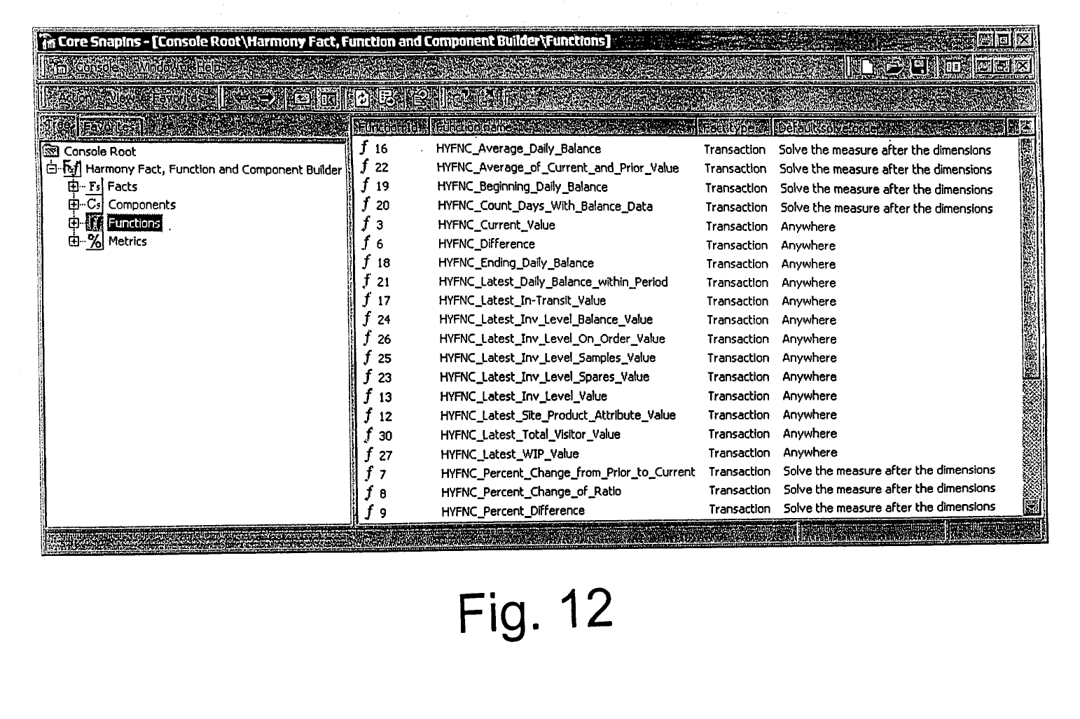

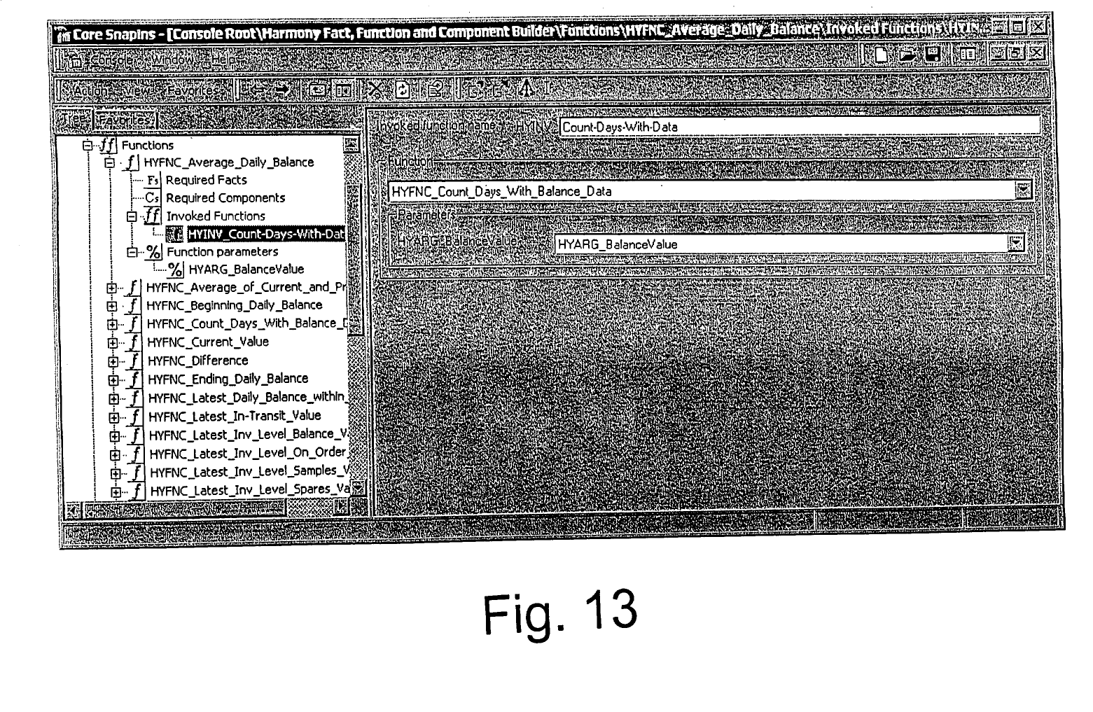

FIG. 12 shows an exemplary interface for accessing functions, consistent with the present invention. FIG. 11 shows an exemplary interface for manipulating functions, consistent with the present invention. Therein, a client can set a dimension solve order for each function indicating where a measure should be computed in relation to a dimension e.g., Solve the measure after the dimensions; Solve the measure before the dimensions; or Anywhere. In addition, MDX text can also be added to a function description.

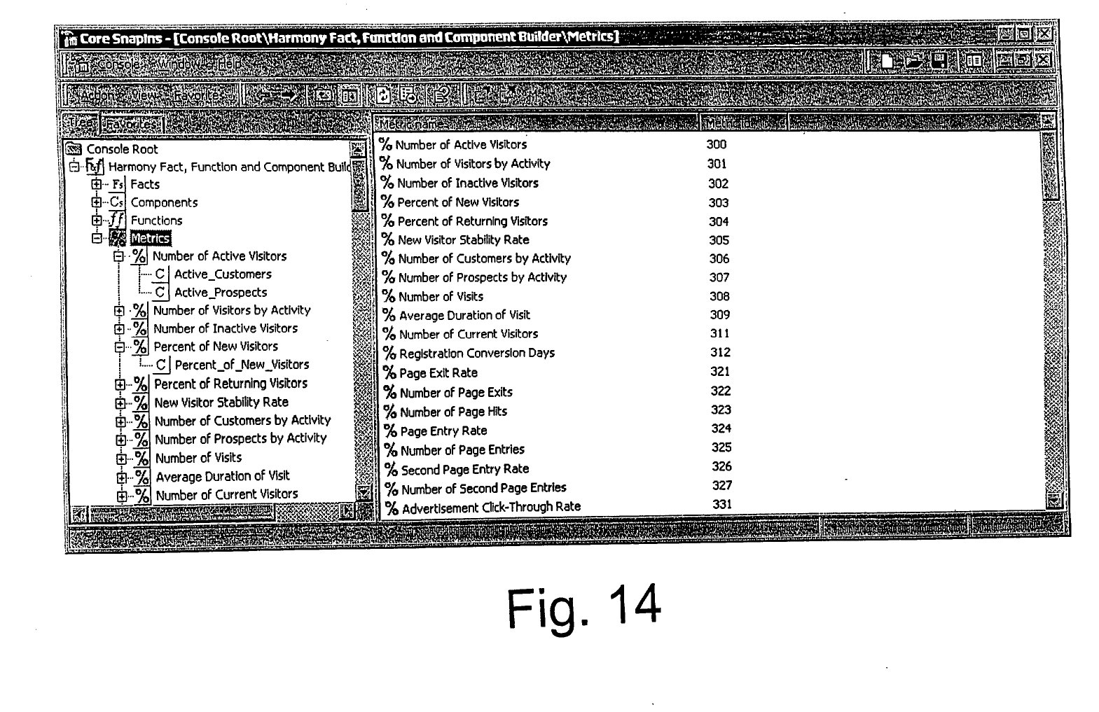

FIG. 13 shows an exemplary interface for manipulating invoked functions, consistent with the present invention. Therein, a client can select a Function and a parameter to be associated with the invoked function.

FIG. 14 shows an exemplary interface for accessing metrics, consistent with the present invention.

In one embodiment, metrics engine both maintains the information, such as that depicted in FIGS. 6-14, and uses this information to translate a client query into a different query. In one embodiment, a client query contains a metric which is associated with one or more components. This component is represented by a subset of the query's calculated members. Thus, in one embodiment, the client query is transformed into a different query with associated solve orders.

In one embodiment, the client query is transformed into a different query using a multi-step process which parses the client query. The process iterates over a metric's associated components, and for each component, generates a measure name and associated MDX text by performing the following actions. First, the process creates measure definitions for any facts or components marked as required by a particular component's associated function. Next, the process builds MDX text to be associated with the measure built to implement the component by substituting measures representing the component's parameters for corresponding parameter symbols in the MDX associated with the component's function. For the invoked functions corresponding to the component's function, the process generates names and builds the appropriate MDX text for the invoked functions. Finally, the process updates the Solve Orders for all of the resulting measures.

In this embodiment, the above-described recursive process may lead to an exposure of facts, components or invoked functions that have themselves as required measures. These cases are circular references, and may be impermissible because evaluation of the corresponding metric is not defined.

In one embodiment, an exemplary algorithm is used to transform a client query containing an aggregate function, into a different query that can be resolved by Analysis Services 2000™. Consider, for example, a case in which a client transmits a MDX query with the following calculated member included in a WITH clause:

MEMBER [My Dimension].[Total Member] As ‘Aggregate([Sample Set], MyNumericExpression)’

where ([My Dimension].[Total Member] is the new calculated member that is being created; [Sample Set] is some definition of a valid MDX set either inline or referencing a set that was defined elsewhere; and MyNumericExpression is a valid MDX numeric expression. MyNumericExpression may be an optional parameter upon which the algorithm does not depend.

If [Sample Set] is the empty set, there are no members to aggregate over so the result is null. The Metrics engine can simply replace “aggregate” with “sum” and the underlying data source will correctly calculate the formula.

Suppose [Sample Set] contains members from one or more dimensions that apply to the metric, which we will refer to as Dim1, Dim2, . . . , DimN. In order to correctly interpret the client query, the metrics engine determines from the metric definition whether these dimensions are additive for the metric (i.e. does the metric definition support aggregating members of the dimension.) If one of the dimensions in [Sample Set] is not additive, the metrics engine returns an appropriate error message to the client.

If all the dimensions are additive, the metrics engine uses the solve orders for each dimension, which are part of the metric definition, to modify the client query. We will refer So1, So2, . . . , SoN as the solve orders for Dim1, Dim2, . . . , DimN respectively. For simplicity of notation, we can also assume that these solve orders are in decreasing order, meaning So1>=So2>= . . . >=SoN. (If they weren't we could simply order them and re-label them as Dim′1, So′1, etc.) The order of the dimensions within [Sample Set] has no effect on the calculation or algorithm.

The metrics engine now generates a new MDX fragment to replace the original calculated member definition. To begin, the calculated member is given the following new definition, where φ is an integer representing the number of times this aggregate logic has been applied to the query.

MEMBER [My Dimension].[Total Member] As

‘Sum(

Head({[Sample Set] As Temp_Set Aggφ}),
Sum(

{[AggDimφ].[Temp_Mbr_Aggφ_1]},
MyNumericExpression

)

)’, Solve_Order = Adjusted_Solve_Order

In the above member definition, Adjusted_Solve_Order is an integer generated by the metrics engine for the client-defined calculated member, which is based on the Harmony metric definition. (Client-specified solve orders are adjusted so the they do not interfere with the other metric-defined solve orders, such as So1, So2, . . . , SoN referenced earlier.)

The dimensions represented by [AggDimφ] (i.e. [AggDim1], [AggDim2], [AggDim3], etc.) are utility dimensions that exist on the underlying cubes, but have no other relationship to the metric being calculated. One embodiment automatically creates these dimensions on the cubes for the metrics engine to perform calculations such as this aggregate logic.

The metrics engine now adds the following calculated member to the generated query. This member sums the members of Dim1 with the appropriate solve order, which is So1.

MEMBER [AggDimφ].[Temp_Mbr_Aggφ_1] As

‘Sum(

Extract(

Temp_Set_Aggφ, Dim1

) As Temp_Set_Aggφ_1,
[AggDimφ].[Temp_Mbr_Aggφ_2]

)’, Solve_Order = So1

Next the metrics engine adds the following calculated member to the generated query. This member sums the members of Dim2 with the appropriate solve order, which is So2, but only over the members that are in tuples of [Sample Set] along with the current member of Dim1.

MEMBER [AggDimφ].[Temp_Mbr_Aggφ_2] As

‘Sum(

Filter(

Extract(

Temp_Set_Aggφ,
Dim2

) As Temp_Set_Aggφ_2,
Rank(

Crossjoin(

{[ Temp_Set_Aggφ_2].Current},
{[ Temp_Set_Aggφ_1].Current}

).Item(0),
Extract(

Temp_Set_Aggφ,
Dim2,
Dim1

)

) > 0

),
[AggDimφ].[Temp_Mbr_Aggφ_3]

)’, Solve_Order = So2

Below is the generic formula for the calculated member related to the I'th dimension of [Sample Set] where 1<I<N. (The 1^{st} calculated member above is logically equivalent, but has been simplified to remove unnecessary Filter and Rank syntax, which will always return the same set as the Extract function for a set with only one dimension.)

MEMBER [AggDimφ].[Temp_Mbr_Aggφ_I] As

‘Sum(

Filter(

Extract(

Temp_Set_Aggφ,
DimI

) As Temp_Set_Aggφ_I,
Rank(

Crossjoin(

Crossjoin(

. . .
Crossjoin(

{[ Temp_Set_Aggφ_I].Current},
{[ Temp_Set_Aggφ_I−1].Current}
),

. . .
{[ Temp_Set_Aggφ_2].Current}

),
{[ Temp_Set_Aggφ_1].Current}

).Item(0),
Extract(

Temp_Set_Aggφ,
DimI,
DimI−1,
. . . ,
Dim2,
Dim1

)

) > 0

),
[AggDimφ].[Temp_Mbr_Aggφ_I+1]

)’, Solve_Order = SoI

For the final dimension of [Sample Set], the metrics engine adds the following calculated member, which differs from the I'th member above only from the standpoint that the sum is taken over the value [AggDimφ].[All] rather than [AggDimφ].[Temp_Mbr_AggφI+1]. If [Sample Set] has only one dimension, this substitution would have taken place in the member [AggDimφ].[Temp_Mbr_Aggφ_{—}1] and there would have been no other members defined.

The member [AggDimφ].[All] is not a calculated member that is defined in the query, but is rather the default member of the [AggDimφ] dimension on the underlying cube. So this is the final calculated member that needs to be defined.

MEMBER [AggDimφ].[Temp_Mbr_Aggφ_N] As

‘Sum(

Filter(

Extract(

Temp_Set_Aggφ,
DimN

) As Temp_Set_Aggφ_N,
Rank(

Crossjoin(

Crossjoin(

. . .
Crossjoin(

{[ Temp_Set_Aggφ_N].Current},
{[ Temp_Set_Aggφ_N−1].Current}
),

. . .
{[Temp_Set_Aggφ_2].Current}

),
{[Temp_Set_Aggφ_1].Current}

).Item(0),
Extract(

Temp_Set_Aggφ,
DimN,
DimN−1,
. . . ,
Dim2,
Dim1

)

) > 0

),
[AggDimφ].[All]

)’, Solve_Order = SoN

Notice that this particular definition of the Nth calculated member sums over all the dimensions in [Sample Set] but is doing so through the Extract function that does not return duplicates. Excluding duplicate records in the final calculation result is intentional for a definition of “aggregate” consistent with one embodiment. However, the result could include the values for duplicate records with a slight modification to the N'th calculated member.

The following is an example of how the above-described exemplary aggregation logic works, without reference to an MDX specific notation. This is not meant to supercede the definition above, but is intended to provide a non-MDX based perspective to describe the logic. This is based on a sample set with three dimensions: Dim1, Dim2, Dim3 with solve orders So1, So2, So3, respectively. Dim1 contains the members A, B, C; Dim2 contains the members O, P; and Dim3 contains the members X, Y, Z.

Suppose [Sample Set] is the following set containing 12 tuples:

{

(A, O, X),
(A, O, Y),
(A, O, Z),
(A, P, X),
(A, P, Y),
(B, O, X),
(B, O, Y),
(B, O, Z),
(B, P, X),
(B, P, Y),
(B, P, Y),
(B, P, Y)

}

The aggregation logic would translate to the following logical definitions of the calculated members:

[Temp_Mbr_Aggφ_{—}3]=(A, O′)=Sum({(A, O, X), (A, O, Y), (A, O, Z)}), Solve_Order=So3

[Temp_Mbr_Aggφ_{—}3]=(A, P′)=Sum({(A, P, X), (A, P, Y )}), Solve_Order=So3

[Temp_Mbr_Aggφ_{—}3]=(B, O′)=Sum({(B, O, X), (B, O, Y), (B, O, Z)}), Solve_Order=So3

[Temp_Mbr_Aggφ_{—}3]=(B, P′)=Sum({(B, P, X ), (B, P, Y )}), Solve_Order=So3

(Note that only one instance of (B, P, Y) is included in the sum, even though there were three in the original set.)

[Temp_Mbr_Aggφ_{—}2]=(A′)=Sum({(A, O′), (A, P′)}), Solve_Order=So2

[Temp_Mbr_Aggφ_{—}2]=(B′)=Sum({(B, O′), (B, P′)}), Solve_Order=So2

[Temp_Mbr_Aggφ_{—}1]=Sum({(A′), (B′)}), Solve_Order=So1

In an embodiment consistent with the present invention, each resulting calculated member either directly corresponds to a fact, or corresponds to the invocation of a function. Associated with each fact and function is a set of specific dimension solve orders and a default dimension solve order. The dimension solve orders indicate where the fact or function should be computed in relation to a dimension: either before the dimension, after the dimension or that it does not matter. For this reason, every calculated member has a set of dimension solve order rules associated with it. Thus, when a query is generated, it becomes necessary to determine and specify an ordering of all of the resulting calculated members.

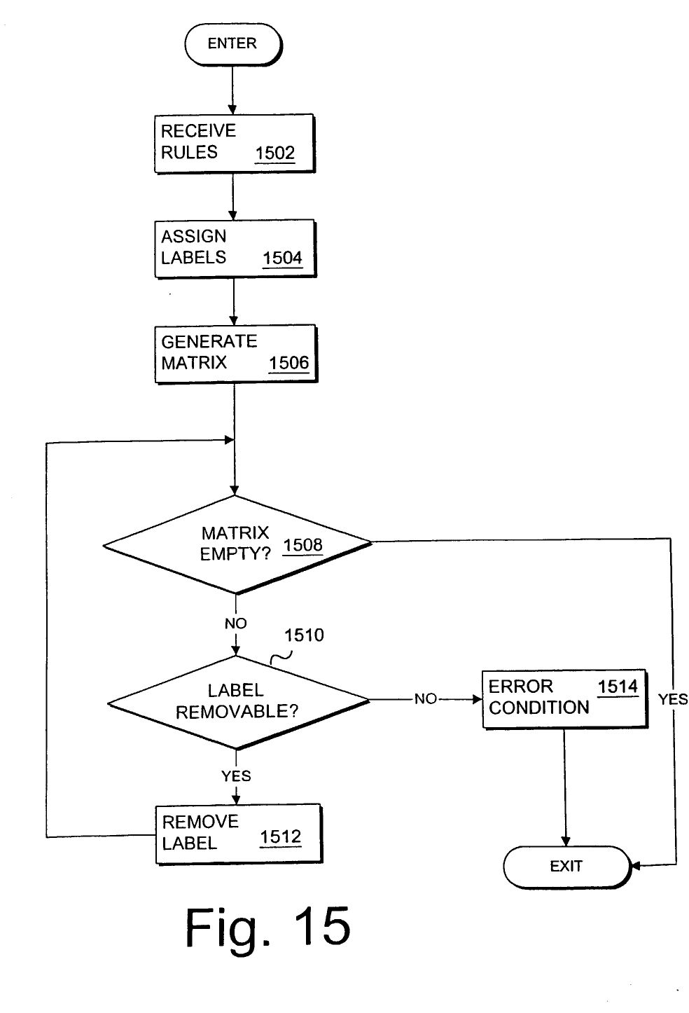

FIG. 15 illustrates a flow diagram consistent with one embodiment in which absolute solve orders are calculated from a list of relative solve orders, e.g., dimension solve orders. First the embodiment receives rules (box 1502) that may be associated with relative solve orders. Next the embodiment assigns labels to calculated members, to dimensions specifically referenced in a sort order rule, and to the dimensions that were not specifically referenced collectively (box 1504). Next the embodiment generates a matrix, in which each cell of the matrix contains either a ‘1’, ‘0’, or ‘−1.’ A ‘1’ indicates that the member or dimension in a column should be computed after the label corresponding to a column. A ‘0’ means that it does not matter whether the labeled entity is computed before or after the corresponding entity. Finally a ‘−1’ means that the referenced entity in a row should be computed before a corresponding column label. It will be apparent to one of ordinary skill that the ‘−1’ and ‘1’ may be reversed with a corresponding difference in sort order. Similarly, other values may be used in the matrix without departing from the scope of the present invention. Next it is determined whether the matrix is empty (box 1508), and if so the process is over, and a suitable absolute solve order is established. On the other hand, if there are still elements remaining in the matrix then it is determined under a predetermined rule whether one of the elements may be removed (box 1510). In one embodiment an element may be removed if the row contains no ‘−1’ and the column contains no ‘1’, which is to say that an element may be removed if nothing must be calculated before it. If none of the elements may be removed, then there are circular dependencies and an error condition has occurred (box 1514). In such an event, it may be necessary for a client to specify a different set of relative sort order rules. If, on the other hand, an element may be removed, then that element received a solve order that is preferred to the remaining elements and the process continues at box 1508.

In one embodiment consistent with the present invention, the following process is used to determine and specify an ordering of all of the calculated members. In the following discussion, the terms ‘measure’ and ‘calculated member’ may be used interchangeably. First, a symbol is assigned to each of the calculated members and to each of the dimensions specifically referred to by any dimension solve order rule. A symbol is also assigned to represent all the dimensions that weren't specifically mentioned in any dimension solve order rule.

Next, a matrix is built by labeling rows and columns with the symbols, and populating each cell in the matrix with a ‘1’, ‘0’ or ‘−1’. In this embodiment, a ‘−1’ indicates that dimension solve order rules for the entity labeling the corresponding row require that the entity labeling the corresponding column fall before it. A ‘0’ indicates that the row entity's rules place no requirements on the column entity's relative position. A ‘1’ indicates that the column entity must fall after the row entity.

In one embodiment, dimension solve order rules are associated with calculated members and not dimensions. Accordingly, rows corresponding to dimensions will consist entirely of ‘0’s. Therefore, in this embodiment, there are no rules associated directly with a dimension regulating the placement of other dimensions or measures. It will be apparent to one of ordinary skill that this procedure may be varied without departing from the scope of the present invention.

In one embodiment, it will be observed that for purposes of the matrix, rules about a solve order for calculated members with regard to other calculated members are dictated by direct interdependencies of measures, facts, components and functions and invoked functions within a data structure that defines the interconnection of these elements. Such interdependencies are described in connection with FIGS. 4 and 5.

Specifically, in the embodiment, when determining measure solve orders for a fact, the only measures to be considered are: (i) measures listed as required cube measures of the fact; and (ii) measures that were generated to represent the fact's required facts.

In this embodiment, when determining measure solve orders for a component, the only measures to be considered are: (i) measures representing required facts of the function being invoked; (ii) measures representing required components of the function being invoked; (iii) measures representing invoked functions of the function being invoked; and (iv) measures representing parameters being passed to a function being invoked, as these measures will represent either facts or components.

In the embodiment, when determining measure solve orders for an invoked function, the only measures to be considered are: (i) measures representing required facts of the function being invoked; (ii) measures representing required components of the function being invoked (iii) measures representing invoked functions of the function being invoked; and (iv) measures representing the parameters being passed to the function being invoked, as these measures will represent facts, components or other invoked functions for the same parent function.

In the three cases illustrated in connection with the above embodiment, all that needs to be taken into account are the direct dependencies. The deeper dependencies are implicit in the process that follows. Since only the direct dependencies are required, solve order rules for one measure with respect to any other measure come down to a determination of whether another measure needs to precede a particular measure, or whether it does not. Accordingly, a matrix value for a measure row against a measure column is going to be either a ‘0’ or a ‘−1’.

A relative solve order of a measure with respect to itself is going to be a ‘0’ since a measure can't have itself as a requirement in a non-circular set of relative sort orders. The foregoing principles may be better understood by reference to the following two examples.

### EXAMPLE 1

### SUCCESSFUL SOLVE ORDER GENERATION

Assume there are dimensions A and B and measures m1 and m2. Symbols or labels are assigned as follows:

M0=A

M1=B

M2=‘All other dimensions’

M3=m1

M4=m2

Assume also that the following rules apply:

m2 is a direct dependency of m1

(m2 must be solved before m1→M4 comes before M3)

A must come before m1, all other dimensions must come after

(M0 before M3; M1,M2 after M3)

B must come after m2, all other dimensions can go anywhere

(M1 after M4; M0, M2 anywhere)

The resulting matrix is as follows:

TABLE T2

| | M0 | M1 | M2 | M3 | M4 |
|---|---|---|---|---|---|
| M0 | 0 | 0 | 0 | 0 | 0 |
| M1 | 0 | 0 | 0 | 0 | 0 |
| M2 | 0 | 0 | 0 | 0 | 0 |
| M3 | −1 | 1 | 1 | 0 | −1 |
| M4 | 0 | 1 | 0 | 0 | 0 |

The algorithm for determining the solve order is to repeatedly remove the row and column corresponding to a single symbol. For a given matrix state, a symbol's row and column may be removed if the row contains no ‘−1’ and the column contains no ‘1’. What this condition means is that there is no symbol that must precede it, nor is there a symbol that it must follow.

The matrix would be processed as follows: row M0 has no ‘−1’, and column M0 has no ‘1’, so M0 can be removed first, resulting in the following matrix:

TABLE T3

| | M1 | M2 | M3 | M4 |
|---|---|---|---|---|
| M1 | 0 | 0 | 0 | 0 |
| M2 | 0 | 0 | 0 | 0 |
| M3 | 1 | 1 | 0 | −1 |
| M4 | 1 | 0 | 0 | 0 |

Row M1 has no ‘−1’, but column M1 has a ‘1’, so M1 can't be removed next.

Row M2 has no ‘−1’, but column M2 has a ‘1’, so M2 can't be removed next.

Row M3 has a ‘−1’ so M3 can't be removed next.

Row M4 has no ‘−1’ and Column M4 has no ‘1’, so M4 can be removed next, resulting in:

TABLE T4

| | M1 | M2 | M3 |
|---|---|---|---|
| M1 | 0 | 0 | 0 |
| M2 | 0 | 0 | 0 |
| M3 | 1 | 1 | 0 |

Columns M1 and M2 each have a ‘1’, so neither M1 nor M2 can be removed next. Row M3 now has no ‘−1’, and column M3 has no ‘1’, so it can be removed next, resulting in:

TABLE T5

| | M1 | M2 |
|---|---|---|
| M1 | 0 | 0 |
| M2 | 0 | 0 |

There are no ‘−1’s or ‘1’s anywhere, so now M1 and M2 can both be removed.

We now have an ordering for the symbols:

M0, M4, M3, M1, M2→A , m2, m1, B, ‘All other dimensions’

### EXAMPLE 2

### UNSUCCESSFUL SOLVE ORDER GENERATION

For this example, the same scenario as in the first example, with the addition of an additional explicitly referenced dimension, C:

Assume there are dimensions A, B and C and measures m1 and m2. The symbols are defined as follows:

M0=A

M1=B

M2=‘All other dimensions’

M3=m1

M4=m2

M5=C

Assume also that the following rules apply:

m2 is a direct dependency of m1

(m2 must be solved before m1→M4 comes before M3)

A must come before m1, all other dimensions must come after

(M0 before M3; M1,M2,M5 after M3)

B must come after m2, C must come before m2, all other dimensions can go anywhere

(M1 after M4; M5 before M4; M0, M2 anywhere)

The resulting matrix is as follows:

TABLE T6

| | M0 | M1 | M2 | M3 | M4 | M5 |
|---|---|---|---|---|---|---|
| M0 | 0 | 0 | 0 | 0 | 0 | 0 |
| M1 | 0 | 0 | 0 | 0 | 0 | 0 |
| M2 | 0 | 0 | 0 | 0 | 0 | 0 |
| M3 | −1 | 1 | 1 | 0 | −1 | 1 |
| M4 | 0 | 1 | 0 | 0 | 0 | −1 |
| M5 | 0 | 0 | 0 | 0 | 0 | 0 |

The matrix would be processed as follows:

Row M0 has no ‘−1’, and column M0 has no ‘1’, so M0 can be removed first, resulting in:

TABLE T7

| | M1 | M2 | M3 | M4 | M5 |
|---|---|---|---|---|---|
| M1 | 0 | 0 | 0 | 0 | 0 |
| M2 | 0 | 0 | 0 | 0 | 0 |
| M3 | 1 | 1 | 0 | −1 | 1 |
| M4 | 1 | 0 | 0 | 0 | −1 |
| M5 | 0 | 0 | 0 | 0 | 0 |

Row M1 has no ‘−1’, but column M1 has a ‘1’, so M1 can't be removed next.

Row M2 has no ‘−1’, but column M2 has a ‘1’, so M2 can't be removed next.

Row M3 has a ‘−1’ so M3 can't be removed next.

Row M4 has a ‘−1’ so M4 can't be removed next.

Row M5 has no ‘−1’, but column M5 has a ‘1’, so M5 can't be removed next.

None of the remaining entities can be removed, which means that a circular dependency must exist among the remaining dimensions and measures. In one embodiment, a different rule is applied in an attempt to narrow down the sources of the circular dependency.

At this stage, a symbol's row and column may be removed if the row contains no ‘1’ and the column contains no ‘−1’. This will successively remove symbols whose solve orders can be set later than the remaining symbols since this condition means that there is no symbol that must follow it, nor is there a symbol that it must precede.

Applying this ‘find the next-last item’ rule results in the following:

Row M1 has no ‘1’ and column M1 has no ‘−1’, so M1 can be removed next.

TABLE T8

| | M2 | M3 | M4 | M5 |
|---|---|---|---|---|
| M2 | 0 | 0 | 0 | 0 |
| M3 | 1 | 0 | −1 | 1 |
| M4 | 0 | 0 | 0 | −1 |
| M5 | 0 | 0 | 0 | 0 |

Row M2 has no ‘1’ and Column M2 has no ‘−1’, so M2 can be removed next.

TABLE T9

| | M3 | M4 | M5 |
|---|---|---|---|
| M3 | 0 | −1 | 1 |
| M4 | 0 | 0 | −1 |
| M5 | 0 | 0 | 0 |

Row M3 has a ‘1’, so M3 can't be removed next.

Row M4 has no ‘1’, but column M4 has a ‘−1’, so M4 can't be removed next.

Row M5 has no ‘1’, but column M5 has a ‘−1’, so M5 can't be removed next.

At this point, the remaining entities are all involved in circular dependencies. It's possible for there to be multiple, independent circular references; however, all that the irreducible matrix reveals is the set of dimensions and measures that prevent the generation of a valid set of solve orders.

In this case, there happens to be a single circular reference involving three measures and dimensions. Specifically, the measures, m1 and m2, and the dimension, C, have related relative rules that cannot be resolves to valid solve orders. Looking back at the rules laid out for these measures, the problem becomes

A must come before m1; and all other dimensions (including C) must come after, so:

C must come after m1.

There is an explicit rule that says C must come before m2, so:

m2 must come after C

Since m2 must come after C and C must come after m1,m2 must come after m1. The problem arises by combining this implication with the following rule:

m2 is a direct dependency of m1, so:

m2 must come before m1.

It is impossible to satisfy ‘m2 must come after m1’ and ‘m2 must come before m1’ simultaneously, so the problem has been located.

### Special Case: High Dependency Measures

Occasionally a measure is defined which requires that the generated Solve Orders be such that no dimension comes between it and any measures that directly depend on it. A common example of such a measure is one which evaluates to a string that dependent measures will subsequently convert back into a member, set or value. In these instances, if a dimension were assigned a value between that of the two measures, (i.e. after conversion to a string, but before conversion back from a string) it could potentially cause distortion of the value. Being a string, the member isn't intended to be aggregated. (See FIG. 9 Non-aggregatable string).

To deal with these types of measures, the process outlined above is first applied to obtain an initial ordering for the measures and dimensions. To take into account the special nature of the high dependency measures, it's necessary to understand that when the queries are ultimately run, only the relative solve orders between a measure and the set of dimensions is significant, not the relative solve orders between measures. The implications of this are that so long as the relative measure-to-dimension solve orders are preserved, the measures can be rearranged with respect to one another.

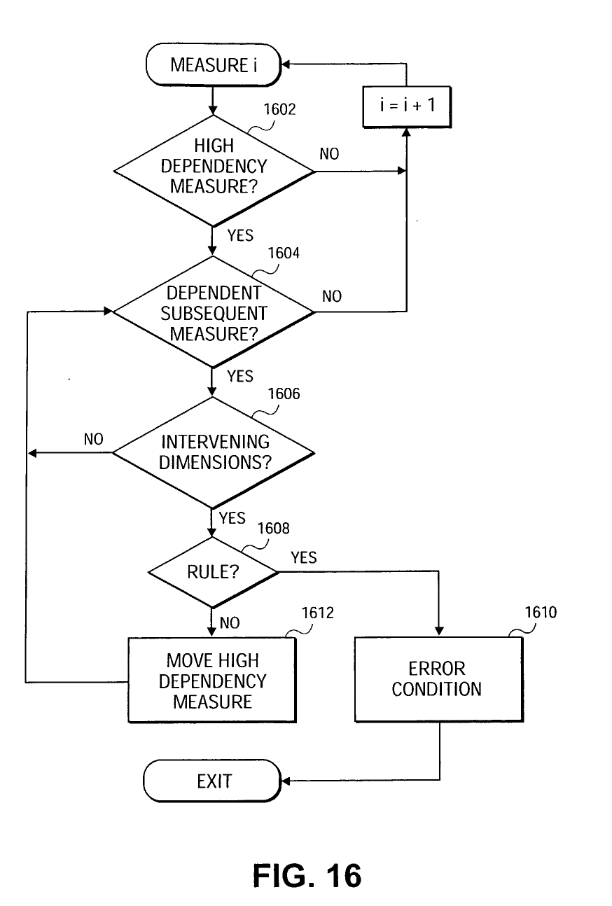

In one embodiment, the measures are rearranged in the final stage of solve order generation. FIG. 16 illustrates a flow diagram consistent with one embodiment in which the final stage of solve order generation accounts for high dependency measures. This embodiment iterates over the initial ordering produced by the first stage, checking each measure in turn. First, the embodiment determines whether or not a measure is a high dependency measure (box 1602). If it is not a high dependency measure, it is left where it is, and the next measure is checked. If, however, it is a high dependency measure, the list of subsequent measures and dimensions is traversed, searching for a dependent measure (box 1604), and keeping track of intervening dimensions. If no dependent measure is found, then the current measure can remain where it is and the next measure is checked. If a dependent measure is found, however, the embodiment determines if there are intervening dimensions (box 1606). If there are no intervening dimensions, nothing needs to be done for this dependent measure and the process continues at box 1604. If there are intervening dimensions, however, the embodiment tries to move the high dependency measure past them. To determine if the high dependency measure may be moved, the embodiment determines if there is a rule for the high dependency measure requiring any of the intervening dimensions to follow it (box 1608). If there is a rule, then the measure can't be moved and an error condition has occurred (box 1610). If, on the other hand, there is no rule then the measure is moved passed the intervening dimensions (box 1612) and the process continues at box 1604.

The foregoing principles may be better understood by reference to the following example.

### EXAMPLE 3

### A HIGH DEPENDENCY MEASURE

Assume F0, is a high dependency measure. Two other measures, F1 and F2, and one dimension, S are also present. Assume also that the following rules apply:

F1 and F2 both depend on F0

(F0 must be solved before F1 and F2)

S must precede F2, and follow F1

(S after F1); (S before F2)

The resulting matrix is as follows:

TABLE T10

| | S | F0 | F1 | F2 |
|---|---|---|---|---|
| S | 0 | 0 | 0 | 0 |
| F0 | 0 | 0 | 0 | 0 |
| F1 | 1 | −1 | 0 | 0 |
| F2 | −1 | −1 | 0 | 0 |

Applying the first set of rules, F0 is first, leaving:

TABLE T11

| | S | F1 | F2 |
|---|---|---|---|
| S | 0 | 0 | 0 |
| F1 | 1 | 0 | 0 |
| F2 | −1 | 0 | 0 |

F1 is next, leaving:

TABLE T12

| | S | F2 |
|---|---|---|
| S | 0 | 0 |
| F2 | −1 | 0 |

S is next, which leaves F2. The order after the first stage is:

F0, F1, S, F2

This is a problem because the solve orders have a dimension (S) falling between the high dependency measure, F0 and its dependent measure F2. The second stage will fix this.

Since F0 is a high dependency measure, subsequent dependent measures are sought while keeping track of intervening dimensions. F1 is a dependent measure, but there are no intervening dimensions, so a move isn't necessary yet. F2 is a dependent measure, and the dimension, S, does intervene, so it's necessary to move F0. Since there is no rule on F0 requiring that S follow F0, F0 can be moved, resulting in:

F1, S, F0, F2

This is the required relative Solve Order.

Other embodiments of the invention will be apparent to those skilled in the art from consideration of the specification and practice of the methods and use of systems consistent with the invention disclosed herein. For instance, embodiments other than a matrix may be used to determine the required solve orders, i.e., solve order rules. It is intended that the specification and examples be considered as exemplary only.

What is claimed is:

1. A method for forming a simplified query having absolute solve orders, the method comprising:
receiving a set of strictly increasing dimension solve order rules associated with a set of calculated measures;
assigning a set of labels to each of the set of calculated measures, the labels being assigned in order;
generating a matrix having rows and columns corresponding to the assigned labels;
receiving a complex query involving aggregation, the complex query corresponding to a multi-dimensional data structure;
parsing the complex query according to a predetermined complex syntax;
determining solve order rules, based on the generated matrix; and
combining information from the parsed complex query with the determined solve order rules, whereby the simplified query is produced.

2. A computer-implemented method comprising:
receiving a set of dimension solve order rules associated with a set of calculated members;
assigning a set of labels to each of the set of calculated members;
generating a matrix corresponding to the assigned labels; and
determining absolute solve orders for a client query based on the generated matrix, wherein the client query involves aggregation of calculated members.

3. A metrics engine comprising:
means for receiving dimension solve order rules associated with a set of calculated members; and
means for determining absolute solve orders for a client query based on the received dimension solve order rules.

4. The metrics engine of claim 3 further comprising:
means for providing global calculated members for formulating a client query.

5. A computer-implemented method comprising:
receiving dimension solve order rules associated with a set of calculated members; and
using the received dimension solve orders rules to translate a client query into a different query with corresponding solve orders.

6. The computer-implemented method of claim 5 further comprising:
providing global calculated members for formulating a client query.

7. A metrics engine comprising:
means for receiving dimension solve order rules associated with a set of calculated members; and
means for facilitating the application of the dimension solve order rules to a relationship between a calculated member and a dimension.

8. A computer-implemented method comprising:
receiving a client query having at least one associated function; and
supporting a function across calculated members that is not supported by an underlying data source.

9. The computer-implemented method of claim 8 further comprising:
querying the underlying data source for a response to the client query.

10. The computer-implemented method of claim 8 wherein the supported function involves aggregation.

11. The computer-implemented method of claim 8 further comprising:
translating the client query into a different query with corresponding solve orders.

12. A computer-implemented method for forming a simplified query having absolute solve orders, the computer-implemented method comprising:
receiving a complex query involving aggregation of calculated members, the complex query corresponding to a multi-dimensional data structure;
determining absolute solve orders; and
combining information from the complex query with the absolute solve orders, whereby the simplified query is produced.

13. The computer-implemented method of claim 12 further comprising:
parsing the complex query.

14. The computer-implemented method of claim 12 further comprising:
receiving a set of dimension solve order rules associated with a set of calculated members.

15. The computer-implemented method of claim 14 wherein the determining absolute solve orders is based on the received set of dimension solve order rules.

16. A computer-implemented method for transforming a client query, the computer-implemented method comprising:
generating at least one member with associated query language for
the client query; and
determining absolute solve orders for generated members.

17. The computer-implemented method of claim 16 further comprising:
receiving a set of dimension solve order rules associated with a set of calculated members.

18. The computer-implemented method of claim 17 wherein determining absolute solve orders is based on the received set of dimension solve order rules.

19. The computer-implemented method of claim 16 wherein the client query contains an aggregate function.

20. A computer-implemented method of claim 16 wherein the at least one generated member is a calculated member.

21. A computing system comprising:
a display to provide an interface to facilitate processing of dimension solve order; and
a processing module for receiving the dimension solve order associated with a calculated member from the interface, the dimension solve order indicating where the member should be computed in relation to a dimension.

22. The computing system of claim 21 wherein the processing module is to provide access to global calculated members from the interface.

23. A computer readable medium containing instructions for controlling a computer system to perform a method, the method comprising:
receiving a set of dimension solve order rules associated with a set of calculated members;
assigning a set of labels to each of the set of calculated members;
generating a matrix corresponding to the assigned labels; and
determining absolute solve orders for a client query based on the generated matrix, wherein the client query involves aggregation across calculated members.

24. A computer readable medium containing instructions for controlling a computer system to perform a method, the method comprising:
receiving dimension solve order rules associated with a set of calculated members; and
using the received dimension solve orders rules to translate a client query into a different query with corresponding solve orders.

25. The computer readable medium of claim 24, wherein the method further comprises:
providing global calculated members for formulating a client query.

26. A computer readable medium containing instructions for controlling a computer system to perform a method, the method comprising:
receiving a complex query involving aggregation of calculated members, the complex query corresponding to a multi-dimensional data structure;
determining absolute solve orders; and
combining information from the complex query with the absolute solve orders to produce a different query.

27. A computer readable medium containing instructions for controlling a computer system to perform a method, the method comprising:
generating at least one calculated member with associated query language for the client query; and
determining solve orders for generated calculated members.

28. The computer readable medium of claim 27, wherein the method further comprises:
receiving a set of dimension solve order rules associated with a set of calculated members.

29. A metrics engine to facilitate application of an aggregate function to calculated members.
